(19) United States
(12) Patent Application Publication
(10) Pub. No.: US 2024/0392598 A1
(43) Pub. Date: Nov. 28, 2024

(54) POOL CLEANING ROBOT

(71) Applicant: BWT ROBOTICS POOL & SPA LTD.

(72) Inventors: Evgeny ADLIVANKIN, Haifa (IL); Efraim GARTI, Zichron Yaakov (IL)

(73) Assignee: BWT ROBOTICS POOL & SPA LTD., Afula (IL)

(21) Appl. No.: 18/202,919

(22) Filed: May 27, 2023

(51) Int. Cl. E04H 4/16; B63H 11/04; C02F 1/00; F04D 3/00; F04D 13/06; F04D 13/08

(52) U.S. Cl. CPC E04H 4/1654; B63H 11/04; C02F 1/001; F04D 3/00; F04D 13/0606; F04D 13/086; C02F 2103/42

(57) ABSTRACT

A pool cleaning robot apparatus including: a housing; a propulsion system for propelling the pool cleaning robot along a submerged surface of the pool; a pump for drawing water from the pool into the housing through an inlet and expelling the water through an outlet; a filter for trapping debris that is in the indrawn water; and a motor for operating at least the pump, wherein a part of the motor is directly exposed to the water of the pool, to facilitate direct water cooling of the motor.

### TECHNICAL FIELD OF THE INVENTION

The present invention relates generally to swimming pool cleaners, and in particular to pool cleaning robots that include one or more motor(s) with direct water cooling system in combination with an enhanced durability of the motor compartment.

### BACKGROUND OF THE INVENTION

In many swimming pools, pool cleaning robots are often employed for routine pool cleaning and maintenance. Commonly, pool cleaning robots include one or more motors that are attached to a pump and/or a propulsion system allowing the pool cleaning robot to filter water and move on the bottom and side surfaces of a pool. The motors are usually located within a sealed, watertight compartment. During operation, torque generated by a motor is transferred outside of the compartment, for example, to impellers or propellers of a pump or propulsion device.

In FIG. 1, a typical watertight motor compartment 101 of a state-of-the art (prior art) pool cleaning robot is shown. Watertight compartment 101 is typically made of plastic material, having a pump motor 102 located inside. Pump motor 102 may be attached to watertight motor compartment 101 via a metallic heat conducting flange 103 and thus enables rotation of pump impeller 106.

In FIG. 2, a cross-section view of the watertight motor compartment 201 of a pool cleaning robot shown in FIG. 1 is disclosed. The transmission of torque generated by motor 202 to impeller 206 may proceed via rotating shaft 205. To prevent water intrusion into the motor compartment 201, part of motor shaft 205 may be surrounded by a rotating seal 204. e.g. an oil retaining seal, that is located at the boundary of compartment 201 and surrounding water.

During operation of the robot, motor 202 of the pool cleaning robot may be cooled by transmission of heat via flange 203 to water that surrounds the robot. However, as a result of the size and location of the flange 203, pool cleaning robots frequently suffer from inefficient cooling due to insufficient heat dissipation from the motor. Thus, to avoid overheating of the motor it may be required to limit the operating times or operation speed of pool cleaning robots.

Additionally, the close proximity of the shaft seal to the metallic flange and the rotating shaft may lead to friction between the components that may result in a reduced torque transmission and increased seal wear. Thus, frequent inspection of the water tightness of the seal and increased need for seal replacement may require a high level of maintenance for pool cleaning robots.

One solution to prevent a motor of a pool cleaning robot from overheating may be decreasing load power, and/or modifications to the design of the motor. In FIG. 3, a cross-section view of a watertight motor compartment 301 of an alternative pool cleaning robot is shown: The usage of a shaft seal 204 may be avoided by implementing magnetic coupling between inner motor shaft 305 and outer load shaft 310 which is, for example, connected to an impeller 306 as shown in the cross-section view of motor compartment 301. Rotation of motor shaft 305 by motor 302 may lead to the rotation of magnetic discs 308a carrying permanent magnets 309a. Magnetic discs 308a carrying permanent magnets 309a may be separated by a watertight compartment from magnetic discs 308b of the load shaft 310 carrying permanent magnets 309b and enable transfer of the rotation of the motor shaft 305 to impeller 306 via magnetic coupling.

This alternative way of torque transmission may reduce the wear of some components of the pool cleaning robot since the friction that arises by using seal 204 and flange 203, as detailed in FIG. 2, is avoided. However, the removal of seal 204 and metallic flange 203 substantially limit the transmission of heat that is generated by motor 202 inside watertight compartment 201 (as shown in FIG. 2). The limited heat dissipation may lead to an increased internal pressure within the watertight compartment that may result in material fatigue, may require the addition of an internal cooling system or may require to operate the robot using a reduced motor power.

Thus, it may be desired to provide a pool cleaning robot that includes a highly efficient heat dissipation system in combination with an enhanced durability of the motor compartment.

### SUMMARY OF THE INVENTION

Disclosed herein is a pool cleaning robot that includes a novel motor arrangement leading to an improved durability of the moisture sensitive electrical- and motor-compartment of the robot.

Advantages of the invention may include a direct heat transfer from a motor of a pool cleaning robot to the surrounding water leading to an efficient cooling of the motor by the pool water during its operation. Further advantages of the invention may include an improved water tightness of the motor-compartment due to the use of static seals in combination with a magnetic coupling of a rotatable motor shaft to a load shaft coaxial to the rotatable motor shaft.

Further advantages of the invention may include the removal of cooling devices and shaft seals within the motor-compartment.

The following is a simplified summary providing an initial understanding of the invention. The summary does not necessarily identify key elements nor limit the scope of the invention, but merely serves as an introduction to the following description.

According to a first aspect, an embodiment of the present invention may provide a pool cleaning robot apparatus comprising: a housing; a propulsion system for propelling the pool cleaning robot along a submerged surface of the pool; a pump for drawing water from the pool into the housing through an inlet and expelling the water through an outlet; a filter for trapping debris that is in the indrawn water; and a motor for operating at least the pump, wherein a part of the motor is directly exposed to the water of the pool, to facilitate direct water cooling of the motor.

In some embodiments, the motor is a brushless motor.

In some embodiments, the part of the motor is a cylindrical wall of the motor.

In some embodiments, the motor further operates the propulsion system.

In some embodiments, the motor is connected to a rotatable motor shaft at a front part of the motor and wherein the front part of the motor including a rotatable motor shaft, is surrounded by a first watertight compartment.

In some embodiments, the torque from the rotatable motor shaft to the load shaft is transmitted through the first compartment without the use of rotating seals.

In some embodiments, the rotatable motor shaft is magnetically coupled to a load shaft coaxial to the rotatable motor shaft.

In some embodiments, a rear part of the motor is surrounded by a second watertight compartment.

In some embodiments, the motor is connected to a rotatable motor shaft at a front part of the motor and the front part of the motor, including a rotatable motor shaft, is surrounded by a first watertight compartment; a rear part of the motor is surrounded by a second watertight compartment; and static seals are located between the first watertight compartment and the front part of the motor and between the second watertight compartment and the rear part of the motor.

In some embodiments, the static seals prevent the water from penetrating into the watertight compartment.

In some embodiments, the motor is cooled by direct heat-transfer from the middle part of the motor to the water.

In some embodiments, the temperature of the motor is controlled by the temperature of the water.

In some embodiments, the apparatus includes a scrubber further including a motor.

In some embodiments, the load shaft is connected to an impeller of the pump.

In some embodiments, the load shaft is connected to a driving propeller of the propulsion system.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, may be understood by reference to the following detailed description when read with the accompanied drawings. Embodiments are illustrated without limitation in the figures, in which like reference numerals indicate corresponding, analogous, or similar elements, and in which:

FIG. 1 (prior art) is an illustration of a watertight motor compartment of a motor of a pool cleaning robot apparatus.

FIG. 2 (prior art) is a cross-section view of a watertight motor compartment of a motor of a pool cleaning robot apparatus.

FIG. 3 (prior art) is a cross-section view of a watertight motor compartment of a motor including a magnetic coupling between the inner motor shaft and the outer impeller load.

FIG. 4 is a pool cleaning robot apparatus, according to an embodiment of the present invention.

FIG. 5 is an illustration of a motor assembly of a pool cleaning robot apparatus, according to an embodiment of the present invention, with direct water cooling of the motor.

FIG. 6 is a cross-section view of the pool cleaning robot apparatus of FIG. 5, wherein a part of a motor is directly exposed to the water of the pool, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

According to a first aspect, an embodiment of the present invention may provide a pool cleaning robot apparatus including: a housing; a propulsion system for propelling the pool cleaning robot along a submerged surface of the pool; a pump for drawing water from the pool into the housing through an inlet and expelling the water through an outlet; a filter for trapping debris that is in the indrawn water; and a motor for operating at least the pump, wherein a part of the motor is directly exposed to the water of the pool, to facilitate direct water cooling of the motor.

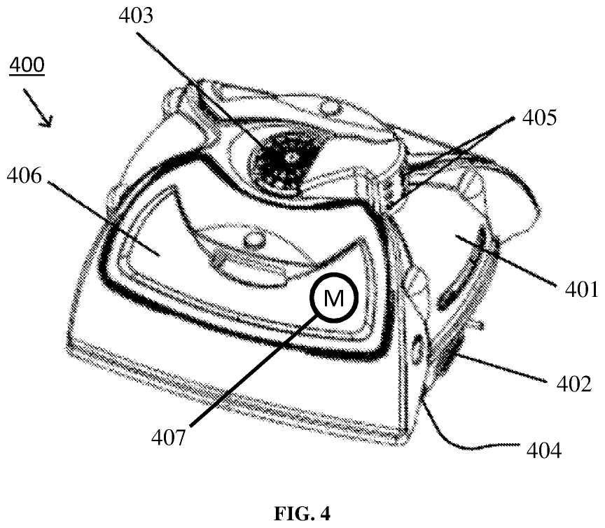

For example, FIG. 4 shows a pool cleaning robot apparatus 400, according to an embodiment of the present invention. Pool cleaning robot 400 comprises a housing 401, a propulsion system 402 for propelling the pool cleaning robot along a submerged surface within the pool, a pump 403 for drawing liquid from the pool into the housing through an inlet 404 and expelling the liquid through an outlet 405: a filter 406 for trapping debris that is in the indrawn water; and a motor 407 directly exposed to the water of the pool, to facilitate direct water cooling of the motor 407. A motor, for example motor 407 may be partially surrounded by one or more watertight compartments. A watertight compartment may prevent water from coming into direct contact with part of a motor that is sensitive to water contact, e.g. electromagnetic coils. In some embodiments, a propulsion system 402 comprises a motor 407. In some embodiments, a propulsion system comprises two motors of motor 407. Alternatively, one or more motors 407 may be connected to propulsion system 402. Motor 407 may be connected to a pump 403. In some embodiments, motor 407 is a brushless motor. In an embodiment, the cooling medium is water of a swimming pool.

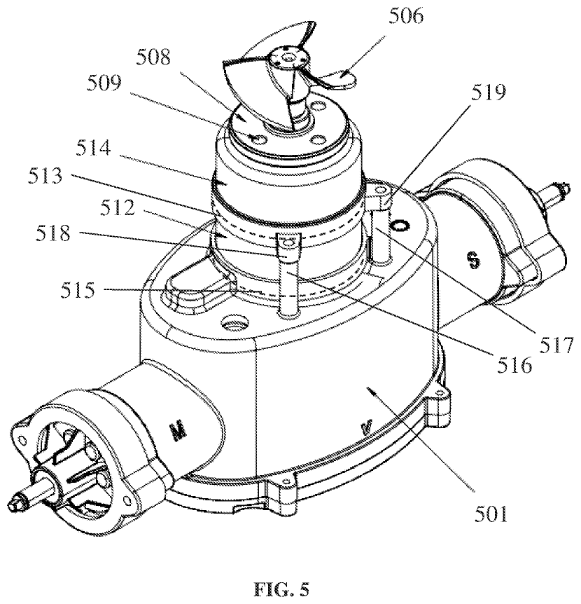

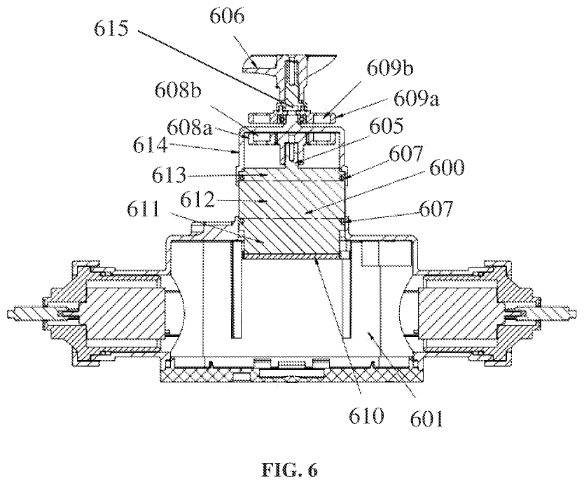

FIG. 5 is an illustration of compartment 501 of a pool cleaning robot apparatus, e.g. pool cleaning robot 400, wherein a part of motor 512 is directly exposed to the water of the pool, according to an embodiment of the present invention. A part of a motor 512 that is exposed to the water of the pool may be a middle part of the motor 512. Part of the motor 512 may have a cylindrical shape and may be waterproof. The middle part of the motor may be connected to the rear part of the motor wherein the rear part of the motor may be surrounded by watertight compartment 501. The front part of the motor may be surrounded by watertight compartment 514. A load shaft may be located at the outside of watertight compartment 514.

Water tight compartment 514 may be surrounded by a static seal 513 e.g. a static O-ring. Static seal 513 may be located between part of motor 512 and water tight compartment 514. Also, water tight compartment 501 may be surrounded by a static seal 515, e.g. a static O-ring. Static seal 515 may be located between part of a motor 512 and water tight compartment 501. Static seals 513 and 515 may prevent water ingress into water tight compartment 501, water tight compartment 514 and/or motor, e.g. motor part 512.

Water tight compartment 514 may be attached to watertight compartment 501. Attachment of water tight compartment 514 to watertight compartment 501 may proceed via connecting means and may increase mechanical stability between water tight compartment 501 and water tight compartment 514, e.g. during operating a pool cleaning robot, such as pool cleaning robot apparatus 400. Water tight compartment 514 may include a plurality of connecting means, for example three connecting means. FIG. 5 exemplary shows connecting means 518 and 519 of water tight compartment 514. The connecting means of water tight compartment 514, e.g. connecting means 518 and 519, may comprise screw holes. Water tight compartment 501 may include a plurality of connecting means, for example three connecting means. FIG. 5 exemplary shows connecting means supports 516 and 517 of water tight compartment 501. The connecting means of water tight compartment 501, e.g. connecting means supports 516 and 517, may comprise screw holes. A plurality of connecting means of water tight compartment 514 may be connected to a plurality of connecting means of water tight compartment 501. For example, screw holes present in the connecting means of 501 and 514 may allow affixation of water tight compartment 501 to water tight compartment 514 using bolts. In an embodiment, water tight compartment 501 is connected to water tight compartment 514. In an embodiment, the connection between water tight compartment 501 and water tight compartment 514 is a flange-type connection. For example, water tight compartments 501 and 514 include a plurality of protruded ridges, lips or rims and flanges of water tight compartments 501 and 514 can be connected with each other using bolts.

The load shaft may include magnetic discs 508 carrying permanent magnets 509 and may be connected. e.g. to impeller 506. In an embodiment, a magnetic disc 508 carries 4 permanent magnets.

In a preferred embodiment, motor 512 is a brushless motor. Since brushless motors are more efficient than brush type motors, they can also contribute to saving on motor power and lead to a reduced heat generation during operation.

The exposure of part of motor 512 to the cool water of the pool allows direct heat transmission from the motor body to the surrounding water during operation of the robot.

FIG. 6 is a cross-section view of a pool cleaning robot apparatus, e.g. pool cleaning robot 400, wherein a part of a motor is directly exposed to the water of the pool, according to an embodiment of the present invention.

Motor 600 may include a rear part of the motor 611, a middle part of the motor 612 and a front part of the motor 613. In some embodiments, a middle part of the motor 612 is a cylindrical wall of motor 600.

In some embodiments, motor 600 is connected to a rotatable motor shaft 605 at a front part of the motor 613. A rotatable motor shaft 605 may be part of the front part of the motor 613. A rotatable motor shaft 605 may be surrounded by a first watertight compartment 614 and a rear part of the motor 611 may be surrounded by a second watertight compartment 601.

In some embodiments, motor 600 is connected to a rotatable motor shaft 605 at a front part of the motor 613 and the front part of the motor 613 also includes a rotatable motor shaft that is surrounded by a first watertight compartment 614.

Rotatable motor shaft 605 is connected to a load shaft 615. Load shaft 615 is located outside first watertight compartment 614 and orientated coaxial to rotatable motor shaft 605 In some embodiments, rotatable motor shaft 605 is magnetically coupled to a load shaft coaxial to the rotatable motor shaft 615. Thus, the torque from the rotatable motor shaft 605 to the load shaft 615 may be transmitted through the first compartment without the use of rotating seals.

In some embodiments, the load shaft 605 is connected to an impeller 606 of a pump. e.g. pump 403 as shown in FIG. 4.

The middle part of the motor 612 may be the part of a motor 600 where stator's magnets (for brush type motors) or motor's windings (for brushless type motors) are located, generating most of the heat. Thus, by directly exposing the middle part of the motor 612 to the water of the pool, heat created by motor 600, in particular in the middle part of the motor 612, during operation of the pool cleaning robot, e.g. pool cleaning robot 400, may directly be transferred to the cool water of a swimming pool. Thus, in some embodiments, motor 600 is cooled by direct heat-transfer from the middle part of the motor 612 to the water. In some embodiments, the temperature of the motor 600 is controlled by the temperature of the water.

The rear part of the motor 611 may be the part of the motor 600 where the motor wires may extend from the motor's body. Thus, the rear part of the motor 611 may the attached to a second part of the water-tight compartment 601. In some embodiments, a rear part of the motor 611 is surrounded by a second watertight compartment 601.

Direct exposure of the middle part of the motor 612 to the water of the swimming pool may be achieved via the use of static seals that separate watertight compartments 601 and 614 from the middle part of the motor 612 that that is exposed to the water of the swimming pool as detailed in FIG. 6. For example, static seals 607 may be located between the first watertight compartment 614, the middle part of the motor 612 and the front part of the motor 613 and between the second watertight compartment 601, the middle part of the motor 612 and the rear part of the motor 611. Alternatively, the front part of the motor 613, e.g. including a rotatable motor shaft, is surrounded by a first watertight compartment 614, the rear part of the motor 611 is surrounded by a second watertight compartment 601 and static seals 607 are located between the first watertight compartment 614 and the front part of the motor 613 and between the second watertight compartment 601 and the rear part of the motor 601. In some embodiments, the static seals 607 prevent the cooling medium, e.g. water of the pool, from penetrating into the watertight compartment, such as compartments 601 and 614. The attachment of the rear part of the motor 611 to a second part of the water-tight compartment 601 may be accomplished via the use of motor fixing plates 610 as shown in FIG. 6.

A motor, e.g. motor 600, may comprise one or more recesses to position static seals, e.g. static seal 607, between motor 600 and the water tight compartments, e.g. water tight compartments 601 and 614. For example, motor 600 comprises two recesses to position static seals between motor 600: a first recess to position static seal 607 between the motor and the first watertight compartment 614, and a second recess to position static seal 607 between the motor and the second watertight compartment 601. In an embodiment, the recess is a groove. In an embodiment, the recess is surrounding motor 600. For example, a recess is located at the front part of the motor 613, surrounding the front part of the motor 613. Alternatively, a recess is located at the middle part of the motor 612, surrounding the middle part of the motor 612. Alternatively, the recess is located at the rear part of the motor 611, surrounding the rear part of the motor. The one or more recesses allow to affix one or more static seals, e.g. seals 607, between motor 600 and second water tight compartments 601 and/or first water tight compartment 614.

The front part of motor 613 is the part of motor 600 that contains rotatable motor shaft 605, which is magnetically coupled to the load shaft 615. Load shaft 615 may be connected to device 606, for example, to an impeller for a motor of water pump 403. Thus, in some embodiments, the motor 600 operates water pump 403.

The rotatable motor shaft 605 connected to the motor 600 is magnetically coupled to a load shaft 615 coaxial to the rotatable motor shaft 605. The load shaft 615 may be connected to device 606.

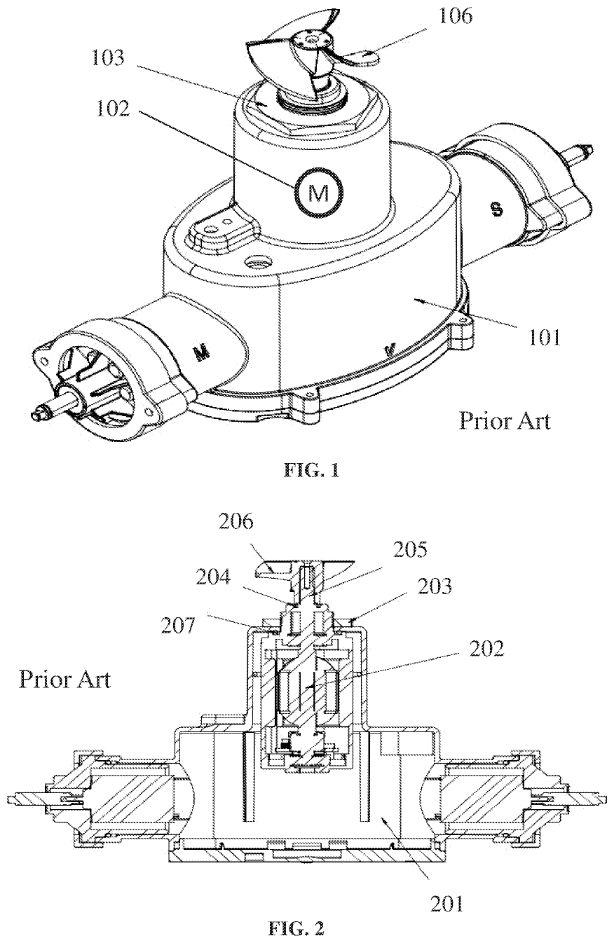

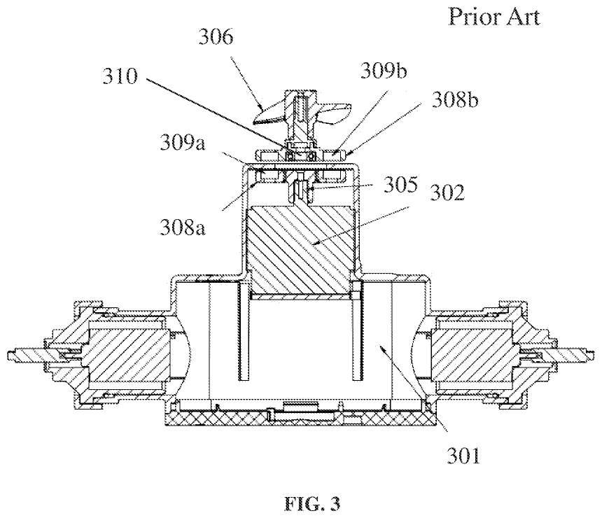

Rotation of motor shaft 605 by motor 600 may lead to the rotation of magnetic discs 608a carrying permanent magnets 609a. Magnetic discs 608a carrying permanent magnets 608b may be separated by a watertight compartment, e.g. watertight compartment 614, from magnetic discs 609a of the load shaft 615 carrying permanent magnets 609b and may enable transfer of the rotation of the motor shaft 605 to impeller 606 via magnetic coupling. Permanent magnets, such as 608b and 609b, are transferring the torque from the rotatable motor shaft 605 to the load shaft 615 through a solid surface, such as watertight compartment 614, without any physical contact between the two magnets. Compared to the state-of-the art solution in FIG. 1, no dynamic shaft seals are required to transmit the torque from the motor to the load shaft. Hence, in view of the motor arrangement disclosed in FIG. 6, no heat is generated as a result of friction that arises from seals surrounding a dynamic shaft.

In some embodiments, a pool cleaning robot, such as robot 400, as disclosed herein includes a motor, e.g. motor 600, for operating the pump and two motors. e.g. motor 600, for operating the propulsion system of the pool cleaning robot, wherein a part of each motor is directly exposed to the water of the pool, to facilitate direct water cooling of the motor.

In some embodiments, a pool cleaning robot, such as robot 400, as disclosed herein includes a motor. e.g. motor 600, for operating the pump and a motor, e.g. motor 600, for operating the propulsion system of the pool cleaning robot, wherein a part of each motor is directly exposed to the water of the pool, to facilitate direct water cooling of the motor.

In an alternative arrangement, the propulsion system is operated by a motor, e.g. motor 600. Thus, in an alternative embodiment, load shaft 615 may be connected to device 606, for example, to a driving mechanism such as a driving propeller that is part of propulsion system 402. Accordingly, motor 600 may operate a propulsion system of a pool cleaning robot, for example robot 400.

Thus, in an embodiment, the present invention allows to maintain the motor temperature of one or more motors of a pool cleaning robot at a low temperature by exposing part of the motor directly to the external water of the pool.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What claimed is:

1. A pool cleaning robot apparatus comprising:
a housing;
a propulsion system for propelling the pool cleaning robot along a submerged surface of the pool;
a pump for drawing water from the pool into the housing through an inlet and expelling the water through an outlet;
a filter for trapping debris that is in the indrawn water; and
a motor for operating at least the pump,
wherein a part of the motor is directly exposed to the water of the pool, to facilitate direct water cooling of the motor.

2. The apparatus of claim 1, wherein the motor is a brushless motor.

3. The apparatus of claim 1, wherein the part of the motor is a cylindrical wall of the motor.

4. The apparatus of claim 1, wherein the motor further operates the propulsion system.

5. The apparatus of claim 1, wherein the motor is connected to a rotatable motor shaft at a front part of the motor and wherein the front part of the motor comprising a rotatable motor shaft, is surrounded by a first watertight compartment.

6. The apparatus according to claim 5, wherein the torque from the rotatable motor shaft to the load shaft is transmitted through the first compartment without the use of rotating seals.

7. The apparatus of claim 5, wherein the rotatable motor shaft is magnetically coupled to a load shaft coaxial to the rotatable motor shaft.

8. The apparatus of claim 5, wherein a rear part of the motor is surrounded by a second watertight compartment.

9. The apparatus according to claim 1, wherein the motor is connected to a rotatable motor shaft at a front part of the motor and wherein the front part of the motor, comprising a rotatable motor shaft, is surrounded by a first watertight compartment;
wherein a rear part of the motor is surrounded by a second watertight compartment; and
wherein static seals are located between the first watertight compartment and the front part of the motor and between the second watertight compartment and the rear part of the motor.

10. The apparatus according to claim 9, wherein the static seals prevent the water from penetrating into the watertight compartment.

11. The apparatus according to claim 1, wherein the motor is cooled by direct heat-transfer from the middle part of the motor to the water.

12. The apparatus according to claim 1, wherein the temperature of the motor is controlled by the temperature of the water.

13. The apparatus according to claim 1, wherein the apparatus comprises a scrubber further comprising a motor.

14. The apparatus according to claim 1, wherein the load shaft is connected to an impeller of the pump.

15. The apparatus according to claim 1, wherein the load shaft is connected to a driving propeller of the propulsion system.
